(19) United States
(12) Patent Application Publication
(10) Pub. No.: US 2011/0296038 A1
(43) Pub. Date: Dec. 1, 2011

(54) SYSTEM AND METHOD FOR CONTINUATION OF A WEB SESSION

(75) Inventor: Sateesh Mandre, Bangalore (IN)

(73) Assignee: UNISYS CORPORATION, BLUE BELL, PA (US)

(21) Appl. No.: 12/839,527

(22) Filed: Jul. 20, 2010

(30) Foreign Application Priority Data
May 28, 2010 (IN) 1230/DEL/2010

(51) Int. Cl. G06F 15/16

(52) U.S. Cl. 709/228

(57) ABSTRACT

A computer-implemented method, executed on a web server, for facilitating continuation of a web session after the web session has been terminated. The method includes initiating a web session having an associated web page with a URL upon receiving a request from a web browser. During the web session, the method includes generating session information, including a transaction identifier and state information. The generated session information is then transmitted to a web browser followed by termination of the web session. After the termination, the web session is resumed by the web server by accepting the session information from the web browser, authenticating the transaction identifier, and validating the client data corresponding to the authenticated transaction identifier. After validation, the web session may be continued at the web page.

### FIELD

This application deals generally with the field of web-based transactions, and more particularly to managing web sessions during web-based transactions.

### BACKGROUND

Typically, a web session involves a web browser at a client machine and a web server at a server machine. The web browser connects to a Uniform Resource Locator (“URL”) and transfers information to, and retrieves information and presents information provided by, the web server. The URL, in general, specifies an identified resource's location and the protocol for retrieving it. Conventional web servers receive a request from a client machine, connect the client machine to the identified resource's location, extract content, such as a web page, and deliver that content to the web browser using the Hypertext Transfer Protocol (“HTTP”).

HTTP is a stateless protocol and does not remember prior transactions with a client machine. Specifically, every time a user enters the URL, a new transaction between the web browser and the web server is initiated, even though the URL was submitted in a previous web session using the same client machine. No provision is provided for continuing a previous web session at the last displayed web page. Accordingly, network bandwidth is wasted, as a user needs to begin the web session afresh each time a discontinuity is encountered during the web session, such as those stemming from a loss of internet connectivity or closure of the web browser by the user.

By way of example, during a web session, the user may initiate a file download activity, which may be interrupted due to loss of internet connectivity. In such a scenario, the portion of the file downloaded before the interruption is lost, as the user again needs to initiate the file download activity from the beginning. In addition, if a login session or a form filling activity is interrupted, the user cannot continue from the last displayed page or the last filled entry. The user must start the login session afresh and fill the form from the beginning.

To allow continuation of a web session, certain web browsers such as Mozilla Firefox support web session management through third-party plug-ins or extensions. Such web session management is generally performed through the application of cookies. Such cookies are sent back and forth between the server and the browser on the client machine, every time a request is made to a URL. The cookies used by the web browsers may include sensitive information and can be easily decrypted and used by hackers, thereby posing a significant security threat.

In addition, when multiple browsers on a single client machine access the same URL, multiple cookies are used to store the state information for the same URL. In that situation, the cookies may provide inaccurate state information.

Further, the web browsers supporting web session management may not provide an option to save partial file download activity. Accordingly, a lost internet connection or any other discontinuity results in loss of the partial file download, which is a considerable waste of time and network bandwidth. Moreover, the web browsers may not, in several cases, return to the exact page that was displayed when the previous web session was discontinued.

### SUMMARY

At present, there exists a need for resuming web sessions in a manner that is efficient and secure. There also exists a need to preserve session information, for example, without limitation, partial file download activity or online form information, such that the file download or form-filling activity can be resumed during a subsequent web session.

The instant application discloses a computer-implemented method, executed on a web server, for facilitating continuation of a web session after the web session has been terminated. The method includes initiating a web session having an associated web page with a URL upon receiving a request from a web browser. During the web session, the method includes generating session information related to the web session, including a transaction identifier and state information. The session information is then transmitted to a web browser followed by termination of the web session. After the termination, the web session may be resumed by the web server by performing certain steps including accepting the session information from the web browser, authenticating the transaction identifier, and validating the client data corresponding to the authenticated transaction identifier. The web session may then be continued at the web page.

The present disclosure provides a system for facilitating continuation of a web, after the web session has been terminated. An exemplary embodiment of the system includes a server-side computing module configured to generate session information related to the web session, including a transaction identifier and state information. The server-side computing module is also configured to transmit the session information to a web browser. A server-initiation module in communication with the server-side computing module is configured to initiate the web session upon receiving a request from a web browser and resume the web session after the web session has been terminated. To resume the web session, the server-initiation module accepts the session information related to the web session from the web browser, authenticates the transaction identifier, and validates client data corresponding to the authenticated transaction identifier. A server-processing module, operatively coupled to the server-initiation module, then continues the web session at the web page.

### BRIEF DESCRIPTION OF THE DRAWINGS

The figures described below and attached hereto set out and illustrate a number of exemplary embodiments of the disclosure. Throughout the drawings, like reference numerals refer to identical or functionally similar elements. The drawings are illustrative in nature and are not drawn to scale.

FIG. 1 is a client-server environment for implementing the embodiments of the present disclosure.

FIG. 2 is an embodiment of a server-side system for facilitating continuation of a web session.

FIG. 3A illustrates a transaction identifier (“TID”) according to an exemplary embodiment of the present disclosure.

FIG. 3B illustrates a transaction structure corresponding to a TID.

FIG. 4 is an embodiment of a browser-side system for facilitating continuation of a web session.

FIG. 5 is a flowchart of an exemplary embodiment of a method for facilitating continuation of a web session.

FIGS. 6A, 6B, 6C, and 6D illustrate an example following an application of the method set out in the present disclosure.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes initiation of a first web session connected to a URL and a second web session after the first web session has been discontinued. The first web session may be discontinued due to session identifier (“SID”) expiration, loss of internet connectivity during file download, saving the web session at any point during browsing or other such reasons. The first web session includes an associated web page and corresponding state information. The web page refers to a page displayed on the web browser, the page being a conventional web page, a login page, or the downloaded percentage of a file. Various details associated with the web state, such as complete URL name, information related to last displayed page, and the like for a conventional web session form the state information. For a file download session, the state information includes complete URL name, the percentage of file download completed during the first web session, and the like. In addition, for a login session, the state information provides information such as complete URL name, login page, and last displayed page for the login session.

The second web session, connected to the URL, may be a continuation of the first web session, or alternatively, may be a new web session connected to the URL. Further, the embodiments described in this disclosure are generally applicable to any web session such as a login session, a file download session, or the like.

### Exemplary Embodiments

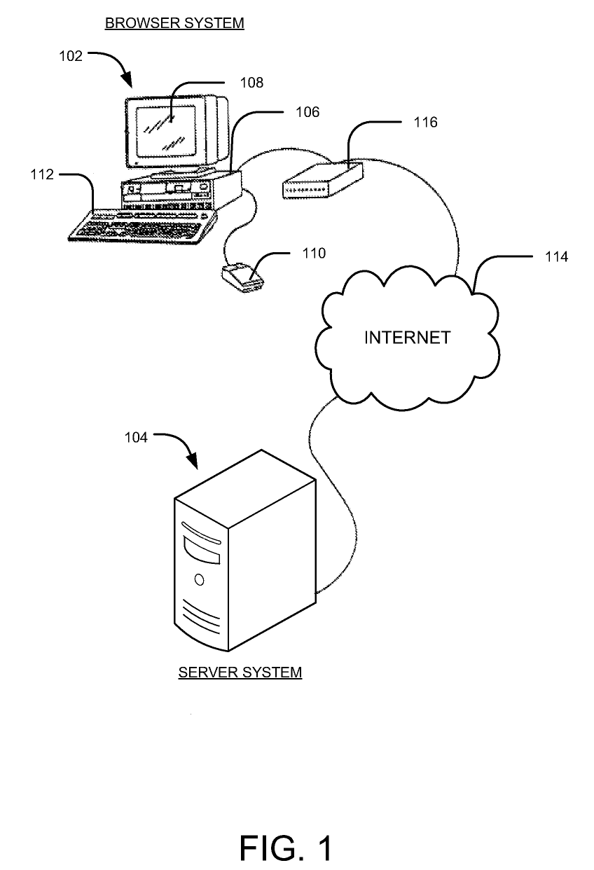

FIG. 1 illustrates a client-server environment 100 used to implement the embodiments of the present disclosure. The client-server environment 100 includes a browser system 102 and a server system 104 communicating with each other. The browser system 102 includes a central processing unit 106, a display 108, a pointing device 110, a keyboard 112, and an internet connection for connecting to the internet 114. The internet connection may be established via an appropriate communications interface, such as router 116, a modem, or other such wired or wireless device. A third party, such as an internet service provider (“ISP”), may be used to establish the internet connection. In the illustrated embodiment, a user, operating the browser system 102, accesses the server system 104 by establishing a connection using the Transmission Control Protocol (“TCP”) or other such control protocol (referred to herein as “TCP connection for clarity) between the browser system 102 and the server system 104. Generally, the browser system 102 communicates with the server system 104 using Hyper Text Transfer Protocol (“HTTP”), Secure HTTP (“HTTPS”), File Transfer Protocol (“FTP”), or other such communication/transfer protocol (referred to herein as a “web session” for clarity) over the TCP connection.

The server system 104 can include server software running thereon which handles requests from the browser system 102.

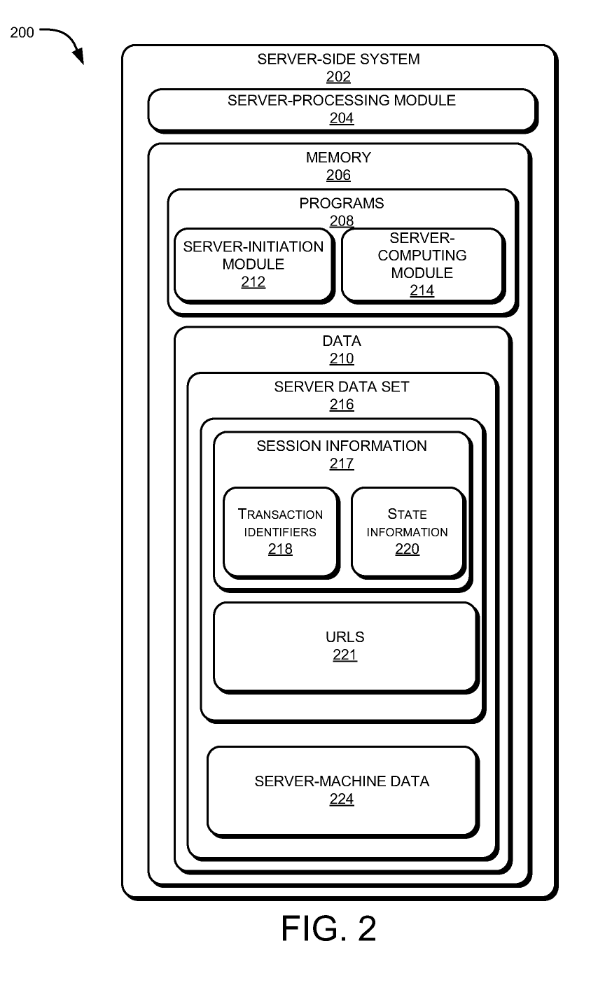

FIG. 2 illustrates an embodiment 200 of the server system 104, such as a server-side system 202, for facilitating continuation of a web session. The server-side system 202 includes a server-processing module 204 coupled to a memory 206. As used herein, the term module comprises one or more software and/or hardware components such as, without limitation, microprocessors, microcomputers, or data processing devices and the instructions, which are executed thereby. In some embodiments, such instructions may be tangibly stored on one or more computer-readable media, such as, without limitation, magnetic media (e.g., floppy disc, hard drive, magnetic tape, etc.), optical media (e.g., compact disc (“CD”), digital versatile disc (“DVD”), etc), and volatile or nonvolatile memory (e.g. flash memory devices, solid state hard discs, memory sticks, random access memory (“RAM”), quantum dots, etc.). The server-processing module 204 fetches and executes computer-readable instructions stored in the memory 206 and can resume a web session, along with other capabilities. The memory 206 also includes programs 208 and data 210.

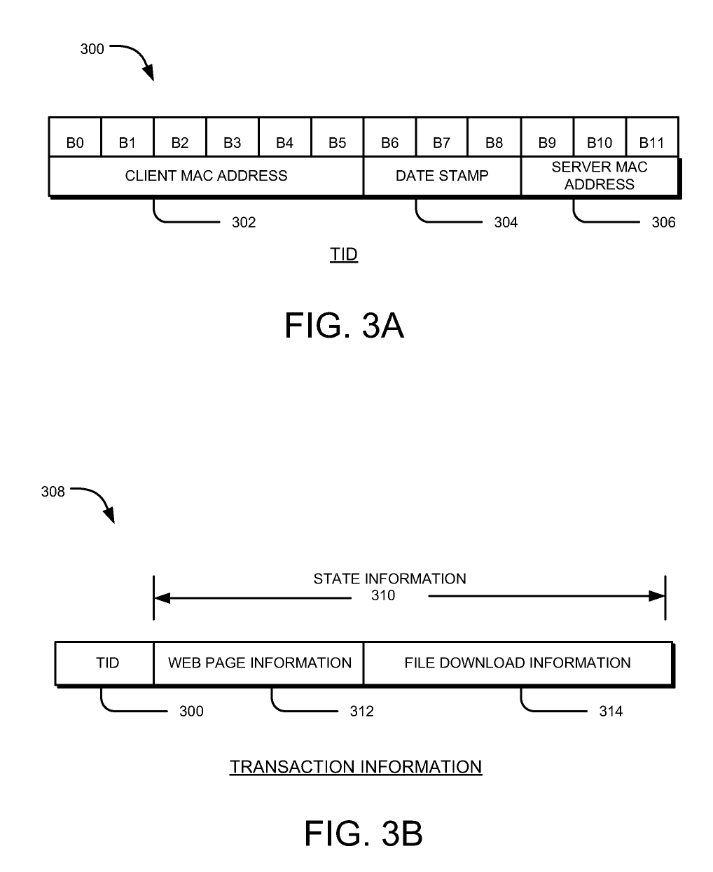

The programs 208 include one or more modules, such as, without limitation, a server-initiation module 212, and a server-computing module 214 for performing various steps allowing continuation of the first web session. The data 210 includes a server data set 216 containing session information 217 including a set of TIDs 218 and a set of state information 220, and corresponding set of URLs 221. Typically, a TID is data corresponding to a particular URL, used in network communications to connect web sessions, thereby facilitating continuation of a web session. A TID identifies a web session which needs to be resumed, while the corresponding state information can provide the web page from which the web session is to be continued. The set of URLs 221 includes all a URL submitted by the user during the web session for which a TID is generated, and corresponding state information is stored in the server data set 216. The set of TIDs 218 and the set of state information 220 are explained in more detail in relation with FIGS. 3A and 3B.

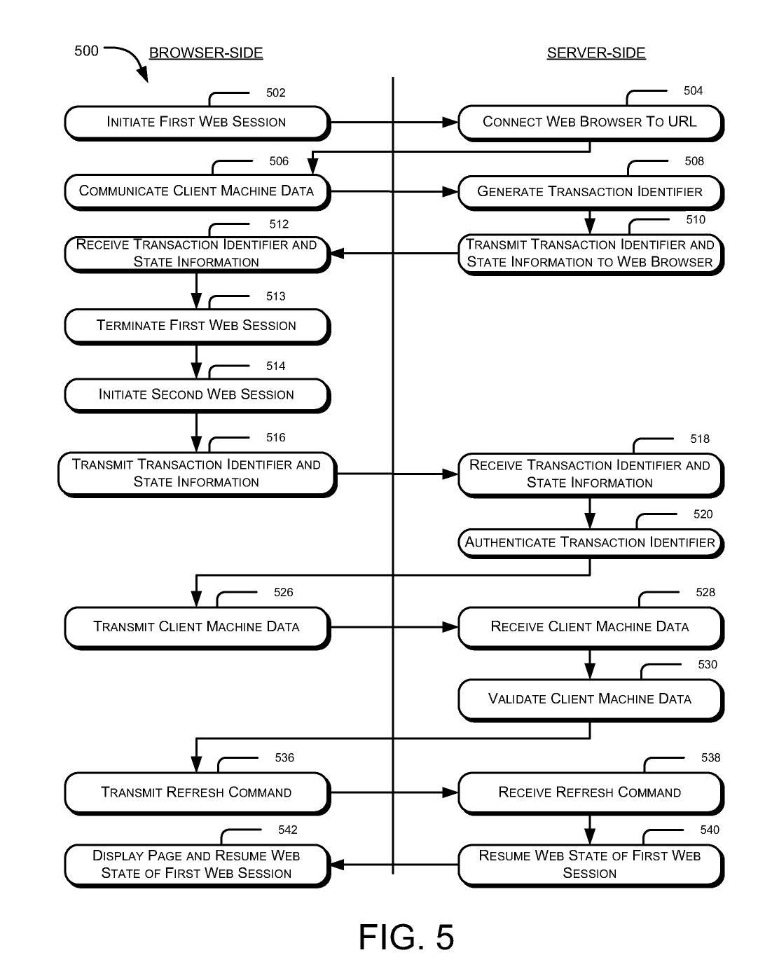

The server data set 216 also includes server-machine data 224 used by the server-computing module 214 for generating the information used in facilitating continuation of a web session. In one embodiment of the disclosure, the server-machine data 224 includes the MAC addresses of the server-side system 202. The MAC address usually encodes the manufacturer's registered identification number and is also known as an Ethernet Hardware Address (“EHA”), hardware address, adapter address, or physical address. It will be understood that any other machine-distinguishing information may be used instead of the MAC address. The various modules and the process of resuming the web session are described in more detail in connection with FIG. 5.

FIG. 3A illustrates an exemplary TID 300 from the set of TIDs 218 stored in the server data set 216. The TID 300 is twelve bytes long (B0 to B11, each represent one byte) and includes a client MAC address 302 followed by a date stamp 304 provided by the web server, and a server MAC address 306. The first six bytes represent the client MAC address 302, the next three bytes represent the date stamp 304, and the last three bytes represent the server MAC address 306. Generally, the higher four bits of the six bytes of the server MAC address 306 are utilized for generating the TID 300. The TID 300 is associated with corresponding state information from the set of state information 220, thereby forming a transaction structure.

FIG. 3B illustrates a transaction structure 308 corresponding to the TID 300. The transaction structure 308 represents the manner in which the TID 300 and corresponding state information 310 are stored in the server data set 216. The TID 300 and the state information 310 form two fields of the transaction structure 308. The state information 310 is associated with a URL from the set of URLs 221 corresponding to the TID 300 and includes two fields—web page information 312 and file download information 314. Typically, the transaction structure 308 includes the TID 300 and the web page information 312. The file download information 314 may be present in case of file download activity. Table 1 details the web page information 312 and the file download information 314 of the transaction structure 308.

TABLE 1

| Field | | | |
|---|---|---|---|
| Index | Field Name | Field Value | Field Type |
| 1 | Web page | Complete URL Name having all the details like | Structure to hold |
| | Information | Scheme name, path as per the URL standards. | URL address |
| | | The URL is the one that was active when save | |
| | | button was clicked. | |
| | | List of web page files downloaded to browser | String array |
| | | system | |
| | | File Attributes | String |
| | | Login Session | Boolean |
| | | Download Session | Boolean |
| 2 | File | File Download Information for multiple files | String array |
| | Download | Download URL Name | String array |
| | Information | Percentage of Download | Float array |
| | | File Server IP address from where to down load | Structure to hold |
| | | | IP address |
| | | File Server URL details | Structure to hold |
| | | | URL address |

In the embodiment described in Table 1, the web page information 312 includes a complete URL name including details, such as a scheme name and path according to the URL standards of the URL corresponding to the TID 300. Further, the web page information 312 can include information regarding the web page files, such as a list of web page files downloaded to the browser system 102 during the first web session, along with their file attributes, such as, without limitation, file size, file date/time (creation, last-modify, last access), archive flag, read-only flag, directory flag, hidden flag, system flag, cyclical redundancy check (“CRC”) value, or the like. As shown in Table 1, the web page information 312 includes fields, which have values that signify whether the first web session is a session requiring a login, a session in which a file is downloaded for use by programs other than and/or in addition to the browser, or another type of web session.

The file download information 314, as shown in Table 1, includes a URL name corresponding to the file download session and the percentage of the file download completed during the first web session. In addition, the file download information 314 may include file server IP address from which the file download activity is to be activated, along with the file server URL details.

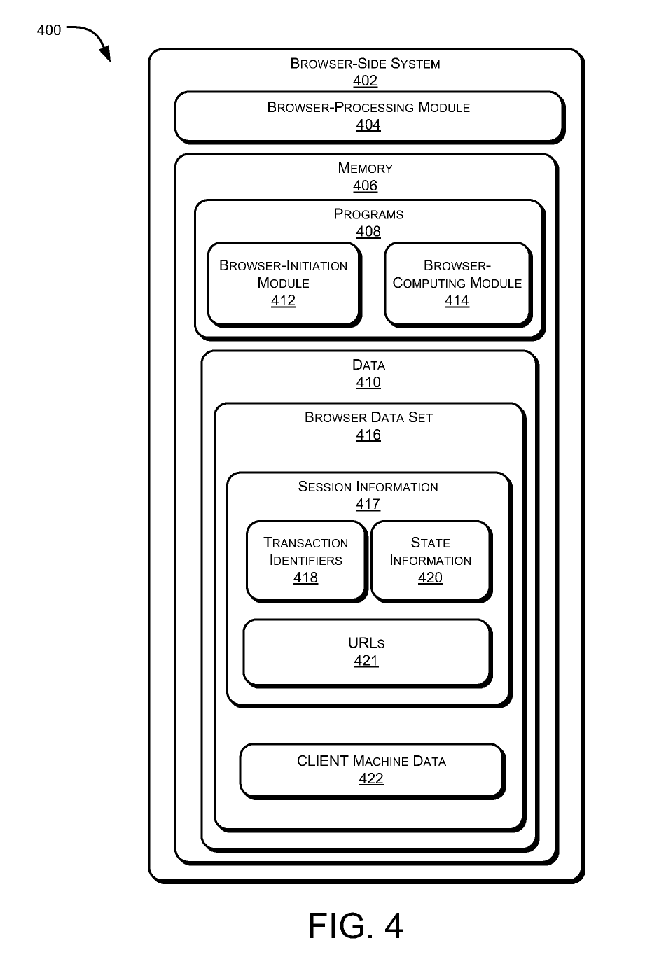

FIG. 4 illustrates an embodiment 400 of the browser system 102, such as a browser-side system 402, for facilitating continuation of a web session. The browser-side system 402 interacts with the server-side system 202 to generate a TID during a first web session, aiding the continuation of the first web session at a later time. The browser-side system 402 includes a browser-processing module 404 coupled to a memory 406 and in communication with the server-processing module 204. The browser-processing module 404 is configured to continue the first web session. The memory 406 includes programs 408 such as a browser-initiation module 412 and a browser-computing module 414, and data 410. The session information 217 (generated by the server-computing module 214) and the corresponding set of URLs 221 are also transmitted to the browser-side system 402 and stored in browser data set 416 of the data 410. The data 410 may include web pages that are used to resume a web session. In some embodiments, the web pages may contain relatively static content and thus, need not be downloaded again to resume the session, as the web pages are locally available at the browser-side system 402. State information includes a list of the web pages and their related or associated attributes. These web pages are deleted only when the user chooses to delete the associated TID.

For the purpose of explanation, the session information and the set of URLs stored in the browser data set 416 are hereinafter referred to as session information 417 and can include a set of TIDs 418, a set of state information 420, and a set of URLs 421. The browser data set 416 also includes client-machine data 422 (associated with the browser-side system 402), which can be transmitted to the server-side system 202 for facilitating generation of the TID. The browser-initiation module 412 and the browser-computing module 414 communicate with the server-initiation module 212 and the server-computing module 214.

The browser-initiation module 412 initiates the first web session with the URL at the server-side system 202. During the first web session, the browser-computing module 414 communicates the client-machine data 422 (utilized for generating the session information 417) to the server-computing module 214. Once the session information 417 is generated, the browser-computing module 414 receives the session information 417 from the server-computing module 214. After the termination of the first web session, the browser-initiation module 412 may resume the web session by sending the session information 417, including a TID from the set of TIDs 418 and state information from the set of state information 420, to the server-side system 202. The browser-initiation module 412 then receives an authentication result for the TID from the web server and transmits the client-machine data 422 for validation to the server-side system 202. Upon successful completion of the validation step, the browser-processing module 404, operatively coupled to the browser-initiation module 412, continues the web session at the last viewed web page.

FIG. 5 illustrates an embodiment of a computer-implemented method 500 for facilitating continuation of a web session. The method 500 is implemented on the server-side system 202 and the browser-side system 402, described in connection with FIGS. 2 and 4, respectively.

The method 500 begins at block 502, where the browser-side system 402 initiates the first web session by sending a request to the server-side system 202. Specifically, the browser-initiation module 412 sends a message to the server-initiation module 212, containing a request for connecting the web browser to a URL. In response to the request, the server-processing module 204 connects the web browser to the requested URL, at block 504, by displaying a web page related to the URL on the web browser. The “web page,” as disclosed herein, is an information set containing different types of information, such as textual information, non-textual information, and interactive information. Each web page displayed on the web browser is associated with a web state and corresponding state information.

Once the web browser is connected to the requested URL, the browser-computing module 414, at block 506, communicates the client-machine data 422 to the server-computing module 214, either automatically or on request from the web browser. The client-machine data 422 is sent automatically when the browser-initiation module 412 initiates a file download activity, when there is an internet discontinuity, when the user saves the web session, or other such times. In some embodiments, when an option to save the web page, displayed on the web browser, is selected, the browser-computing module 414 sends the client-machine data 422 to the server-computing module 214 to facilitate generating the TID. The option to save the web state may be integrated into the web browser. For example, a save option may be present in a menu of a web browser, may appear as a toolbar button, or the like. Such integration may be native to the browser or accomplished by one or more plug-ins, add-ons, or other such enhancements to the browser. The save option may have the ability to save the web page completely including text, graphics, sound and so on. In some embodiments, the web browser may cause the entire web page to be stored. In other embodiments, the web browser may cause portions of a web page to be stored, such portions including, without limitation, the user-entered contents of fields within the web page and the name of the field to which the contents correspond. Once the web browser is closed, these web page portions may be deleted automatically, if the user does not save the web session. Alternatively, if the user saves the web session, the web page portions are associated with a TID and saved. The web pages are deleted when the user deletes the TID. In certain implementations, the web sessions are automatically saved when the browser is closed, which allows a user to resume every web session.

The server-computing module 214 receives the client-machine data 422 from the browser-computing module 414 and may combine the client-machine data 422 with the server-machine data 224 and a date stamp of the web server to generate the TID at block 508. The date stamp may be employed for timing-out the TID after a certain period at the server-side system 202. Such timing-out of the TID eliminates the proliferation of the TIDs in the server-side system 202. A user may delete the TID as well.

The server-computing module 214 utilizes an encryption algorithm, which may be any encryption algorithm known in the art, such as RSA, blowfish, International Data Encryption Algorithm (“IDEA”), or Software-Optimized Encryption Algorithm (“SEAL”) to generate the TID. The generated TID is stored in the server data set 216 along with the state information corresponding to the URL, for which the TID is generated.

Returning to the description of FIG. 5, at block 510, the server-computing module 214 transmits the generated TID and the corresponding state information to the browser-computing module 414 and at block 512, the browser-computing module 414 stores the TID and the state information in the browser data set 416. The web browser and the web server utilize the TID and the state information, stored in data sets 216 and 416, for resuming the web state of the first web session.

After the termination of the first web session at block 513, the web browser initiates the second web session with the URL activated during the first web session, at block 514, by sending an initiation request to the web server. The first web session may be terminated for a variety of intentional or accidental reasons including, without limitation, disruption of internet connectivity during file download, on saving the web session during web browsing, when the SID of the first web session expires, or the like. For initiating the second web session, the browser-initiation module 412 sends a message to the server-initiation module 212, requesting a connection to the URL. In the present embodiment, the second web session resumes the web state of the first web session.

The process of resuming the first web session includes transmitting the TID and the state information corresponding to the requested URL from the browser-initiation module 412, at block 516, to the server-initiation module 212. At block 518, the server-initiation module 212 receives the transmitted TID and the state information for authentication. The server-initiation module 212 authenticates the received TID at block 520 by matching the received TID with the stored TID in the server data set 216, corresponding to the requested URL. In case of a match, the server-initiation module 212 transmits a message to the browser-initiation module 412 to send the client-machine data 422 for validation, indicating that the TID is valid; otherwise, the server-initiation module 212 transmits an error message. At block 526, the browser-side system 402 transmits the client-machine data 422 corresponding to the user's machine, if the TID is valid; alternatively, the browser-processing module 404 receives a request to display an error message on the web browser.

In case the authentication is successful, the server-initiation module 212 receives the client-machine data 422, shown at block 528. The server-initiation module 212, at block 530, validates the received client-machine data 422 by checking whether the received client-machine data 422 is the same as the client machine data utilized during generation of the TID. In certain embodiments of the disclosure, the browser-computing module 414 sends the MAC address of the client-machine for validation to the server-initiation module 212. The received MAC address is validated by matching it against the MAC address used by the server-computing module 214 while generating the TID. The TID includes the MAC address in encrypted form and thus, the MAC address can be extracted from the TID for the purpose of validation.

If the client-machine data 422 is valid, the browser-processing module 404 transmits a refresh command to the server-processing module 204, at block 536; otherwise, the browser-processing module 404 displays an error message on the web browser. If the server-processing module 204 receives the refresh command, at block 538, from the browser-processing module 404, the server-processing module 204 resumes the web state of the first web session, at block 540. For example, the server-processing module 204 sends the last displayed web page of the first web session to the browser-processing module 404. Typically, the server processing module 204 checks the state information stored in the server data set 216 corresponding to the TID. Based on the state information, the server-processing module 204 may transmit the last displayed web page of the first web session, continue a web download from the disconnection point, or continue a login session from the last modified page (after the user performs a successful login operation), thereby resuming the web state of the first web session. Further, the server-processing module 204 transmits a SID, along with the web page to the browser-processing module 404. At block 542, the browser-processing module 404 displays the web state transmitted by the server-processing module 204 and thus resumes the web state of the first web session.

In one embodiment of the present disclosure, a user may save the web page during the second web session by selecting the save option displayed on the web browser. In this case, instead of generating a new TID, the server-computing module 214 updates the existing TID. For updating the existing TID, the server-computing module 214 overwrites the date stamp field in the TID structure with the current date, and updates the corresponding state information by modifying the web page information. In addition, if a file download activity is initiated during the second web session, the server-computing module 214 updates the file download activity of the state information. The server-computing module 214 then transmits the updated TID to the browser-computing module 414, which stores the updated TID in the browser data set 416.

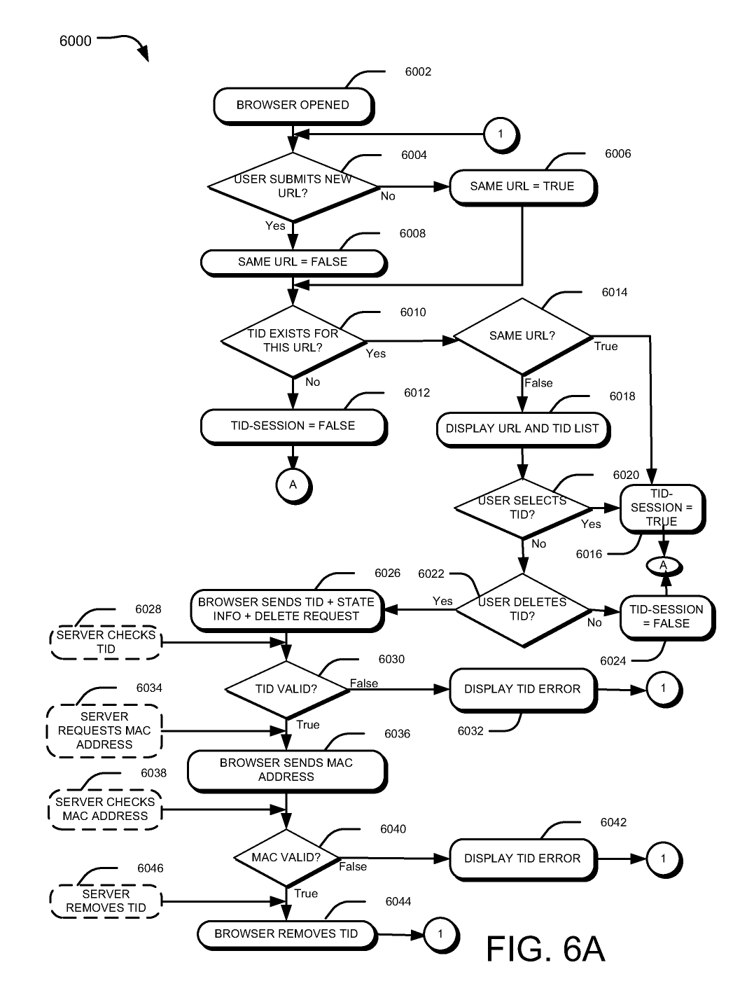

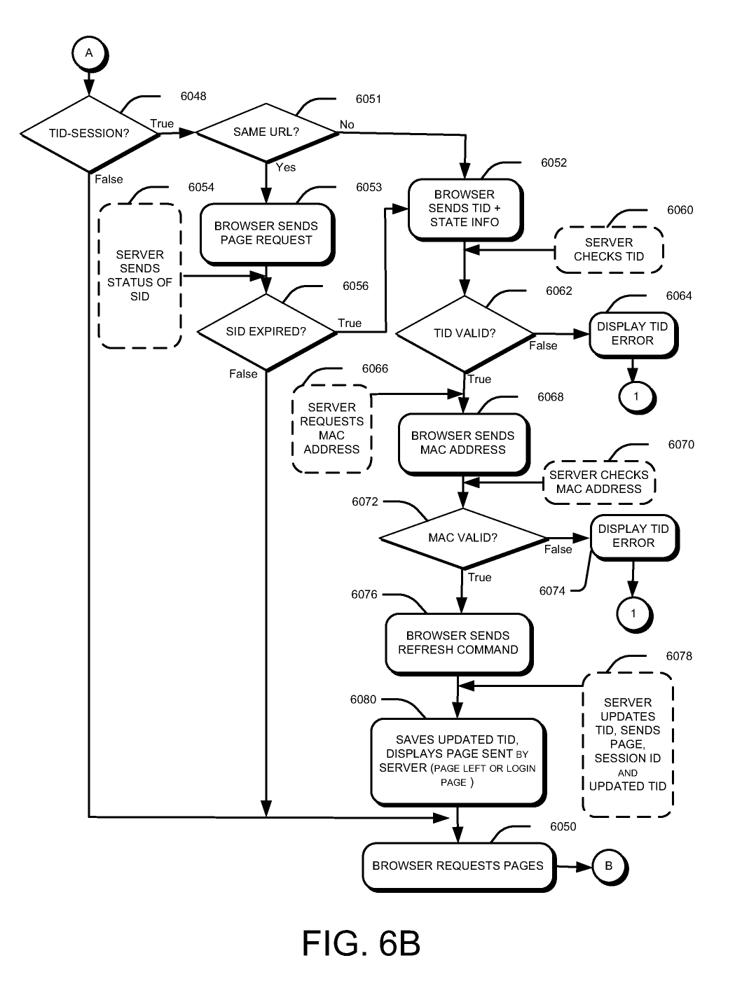

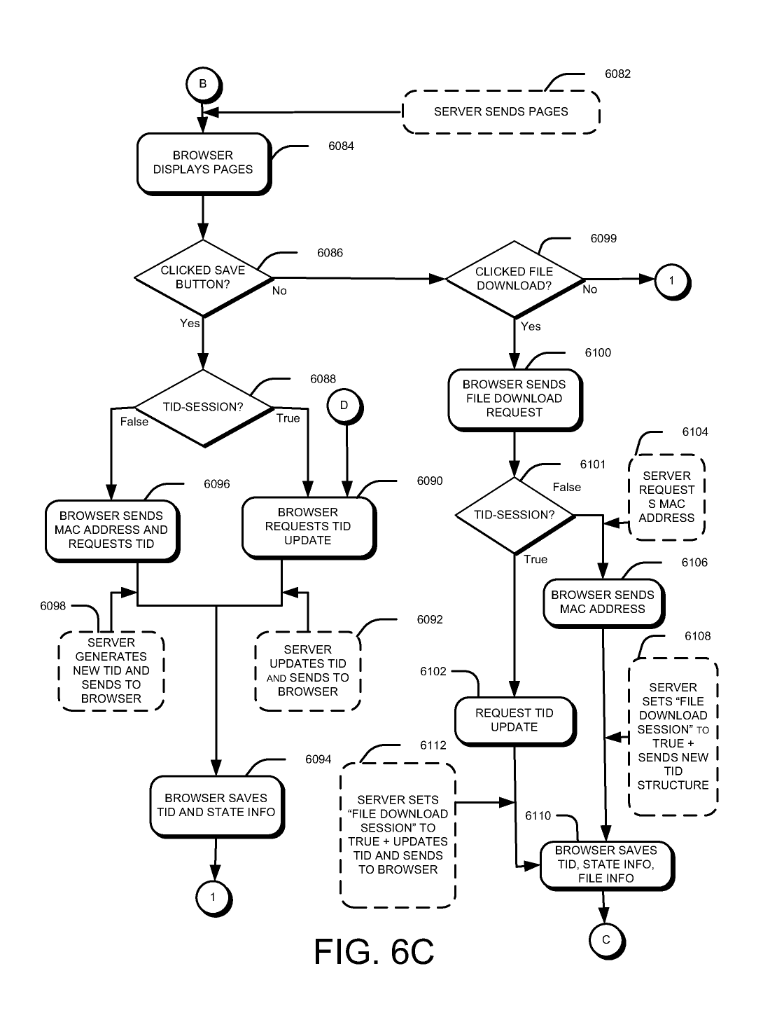

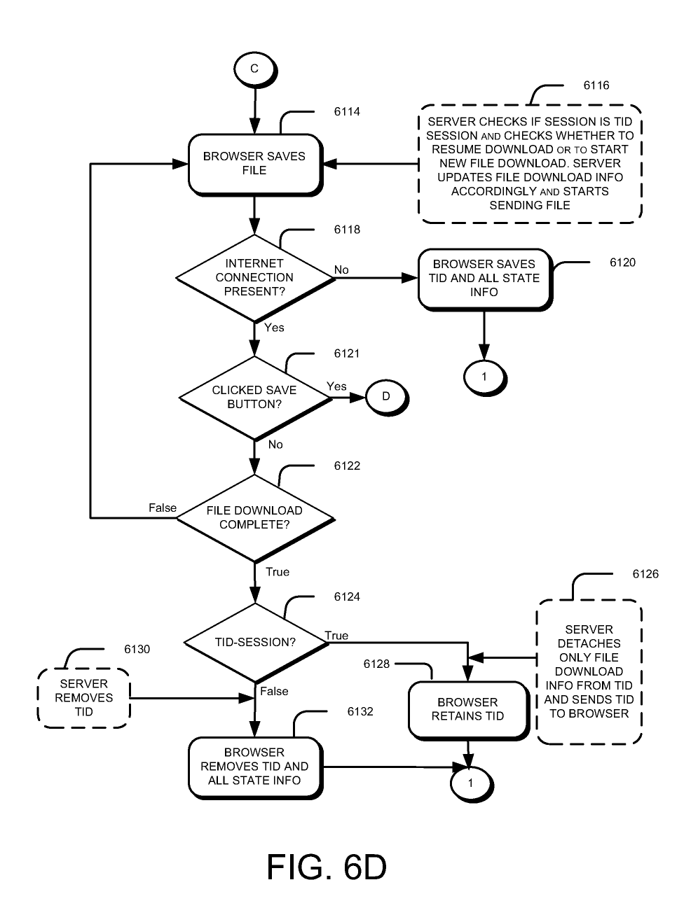

The following exemplary embodiment is provided to further enhance the description of the disclosed system and methods, and follows an application of the method 500 set out in the present disclosure. The method 500 is discussed in an example 6000 and is illustrated using FIGS. 6A, 6B, 6C, and 6D. It will be understood that in the disclosed example 6000, a user may submit a new URL or close the web browser at any point in time. For illustrating the server-side operations, blocks representing web server responses sent to the web browser are shown in dotted lines in FIGS. 6A, 6B, 6C, and 6D.

As illustrated in FIG. 6A, at block 6002, the user at a client machine opens a web browser window and submits a URL, thereby requesting the web server to display one or more web pages associated with the submitted URL. Block 6004 determines whether the user changed the URL or the user is still continuing from the same URL. If the user is at the same URL, the block 6004 proceeds to block 6006, assigning a ‘true’ value to a parameter—“same URL”; otherwise, the block 6004 proceeds to block 6008, assigning a ‘false’ value to the parameter “same URL.”

Both the blocks 6006 and 6008 lead to block 6010, wherein it is determined whether the browser-side system 402 includes a TID corresponding to the submitted URL. If the block 6010 determines that the submitted URL does not have a corresponding TID stored in the browser-side system 402, the block 6012 recognizes that the current web session is not a TID session and assigns a ‘false’ value to a parameter—“TID-session.” Otherwise, if the block 6010 determined that the TID corresponding to the submitted URL is stored in the browser-side system 402, block 6014 determines whether the value of the “same URL” parameter is ‘true’ or ‘false’. If the “same URL” parameter's value is ‘true’, block 6016 assigns a ‘true’ value to the parameter “TID-session”; otherwise, the block 6014 leads to block 6018. The block 6016 leads to a connector A.

The block 6018 displays a set of URLs and corresponding set of TIDs, stored in the browser-side system 402, on the web browser. In addition, the submitted URL is highlighted in the displayed set of URLs for the user's reference, and the user may select a TID corresponding to the highlighted URL from the set of TIDs, thereby assigning a ‘true’ value to the parameter “select TID.” Alternatively, if the user does not select any of the displayed TIDs, a ‘false’ value is assigned to the parameter “select TID.” Block 6020 determines whether the value of the parameter “select TID” is ‘true’ or ‘false’. If the value of the parameter “select TID” session is ‘true’, the block 6020 leads to the block 6016, where the “TID-session” parameter's value is ‘true’ and the block 6016 further leads to the connector A; otherwise, the block 6020 leads to block 6022.

The block 6022 determines whether instead of selecting the TID, the user selects a delete option, displayed on the web browser, for deleting the TID. If the delete option is selected, a “delete TID” parameter's value is set to ‘true’; otherwise, the “delete TID” parameter's value is set to ‘false’. If the “delete TID” parameter's value is ‘false’, the block 6022 leads to block 6024, where the “TID-session” parameter's value is set to ‘false’; otherwise, the block 6022 leads to block 6026. The block 6024 further leads to the connector A.

The block 6026 transmits a request to the server-side system 202 for deleting the TID. Typically, the block 6026 transmits the TID and the state information corresponding to the TID stored in the browser-side system 402, along with the request to delete the TID to the server-side system 202.

On receiving the request to delete the TID, block 6028 checks the TID in the server-side system 202 to assign a value to a “TID valid” parameter. The block 6028 sets the value of the “TID valid” parameter as ‘true’ if the TID is stored in the server-side system 202 corresponding to the submitted URL; otherwise, the “TID valid” parameter's value is set to ‘false’. If block 6030 determines that the “TID valid” parameter's value is ‘false’, the block 6030 leads to block 6032 which displays an error message on the web browser. If the error message is displayed, the web browser waits for a user action, such as typing a new URL, as represented by connector 1, thus returning to the block 6004.

Otherwise, if the “TID valid” parameter's value is ‘true’, as determined by the block 6030, the server-side system 202 transmits a message to the browser-side system 402 at block 6034 requesting the MAC address of the client machine. Upon receiving the request, the block 6036 communicates the MAC address to the server-side system 202. At block 6038, the server-side system 202 determines whether the MAC address is valid. If the MAC address is valid, the server-side system 202 either sets a “MAC valid” parameter's value as ‘true’; or, a ‘false’ value is assigned to the “MAC valid” parameter.

Block 6040 determines whether the value of the “MAC valid” parameter is ‘true’ or ‘false’. If the “MAC valid” parameter value is ‘false’, the block 6040 leads to block 6042, which displays an error message on the web browser. Otherwise, if the “MAC valid” parameter's value is ‘true’, the block 6040 leads to block 6044, which removes the TID from the browser-side system 402. In addition, on determining that the “MAC valid” parameter's value is ‘true’, block 6046 deletes the TID from the server-side system 202 as well. Once the TID is deleted, the web browser waits for a user action, such as typing a new URL, as represented by the connector 1, thus returning to the block 6004.

FIG. 6B is a continuation of FIG. 6A, as shown by the connector “A.” As illustrated in FIG. 6B, if the option to delete the TID is not selected, block 6048 determines the value of the “TID-session” parameter. If the value of the “TID-session” parameter is ‘false’, the block 6048 leads to block 6050, which transmits a request to the server-side system 202 for displaying the web page corresponding to the submitted URL. If the value of the “TID-session” parameter is ‘true’, the block 6048 leads to block 6051. The block 6051 determines whether the value of the “same URL” parameter is ‘true’ or ‘false’. If it is determined that the “same URL” parameter value is ‘true’, block 6053 transmits a request from the browser-side system 402 for displaying the web page to the server-side system 202; otherwise, the block 6051 leads to block 6052. The server-side system 202 checks the status of the SID corresponding to the requested web page. An “SID expired” parameter's value is set to ‘true’ if the SID has expired; otherwise, a ‘false’ value is assigned to the “SID expired” parameter. At block 6054, the server-side system 202 sends the value of the “SID expired” parameter to the browser-side system 402. Block 6056 checks whether the value of the “SID expired” parameter is ‘true’ or ‘false’. If the value of the “SID expired” parameter is ‘false’, the block 6056 leads to the block 6050, where the request to display the web page is transmitted to the server-side system 202; otherwise, the block 6056 leads to block 6052.

The block 6052 transmits the TID and the corresponding state information from the browser-side system 402 to the server-side system 202 to allow resuming the previous session. The server-side system 202 determines whether the TID is valid at block 6060, and accordingly, assigns a value to the “TID valid” parameter. Based upon the response of the server-side system 202, block 6062 determines whether the value of the “TID valid” parameter is ‘true’ or ‘false’. If the “TID valid” parameter's value is ‘false’, the block 6062 leads to block 6064, which displays an error message. After the error message is displayed, the browser waits for a user action, such as typing a new URL, as represented by the connector 1, which leads to the block 6004.

Otherwise, if the “TID valid” parameter's value is ‘true’, the server-side system 202 sends a message to the browser-side system 402 requesting the MAC address of the client-machine, as shown at block 6066. On receiving the request, the browser-side system 402 sends the MAC address of the client machine to the server-side system 202, at block 6068. At block 6070, the server-side system 202 checks the MAC address and assigns a value to the “MAC valid” parameter.

Block 6072 determines the value of the “MAC valid” parameter. If the “MAC valid” parameter's value is ‘false’, the block 6072 leads to block 6074, which displays an error message on the web browser; otherwise, the block 6072 leads to block 6076. After an error message is displayed, the browser waits for the user to type a new URL, as represented by the connector 1, returning to the block 6004.

The block 6076 sends a refresh command from the browser-side system 402 to the server-side system 202. On receiving the refresh command, the server-side system 202 updates the TID corresponding to the submitted URL. On updating the TID, the server-side system 202 transmits the requested web page, the corresponding SID, and the updated TID to the browser-side system 402 as shown at block 6078.

The block 6080 displays the web page sent by the server-side system 202 on the web browser and saves the updated TID in the browser-side system 402. The web page displayed on the web browser is the last viewed page of the previous web session corresponding to the submitted URL. The block 6080 leads to the block 6050, where the browser-side system 402 continues sending the web page request corresponding to the submitted URL to the server-side system 202. The block 6050 leads to a connector B.

In an embodiment of the present disclosure, the web page is a login page, activated during a previous login session. The login session requires the user to input a username and password before browsing through the associated web pages. While resuming the previous login session, terminated due to internet discontinuity, saving by the user, or the like, the block 6078 initially transmits the login page to the block 6080. The block 6080 displays the login page on the web browser where the user may enter the login details. Once the user enters the login details and selects a submit option or another similar option, the browser-side system 402 transmits the login details to the server-side system 202. On receiving and properly validating the login details, the server-side system 202 transmits the last saved or last browsed page associated with the login session to the browser-side system 402. The browser-side system 402 then displays the page transmitted by the server-side system 202 on the web browser, thereby resuming the lost login session. For resuming a login session or a normal session, when dynamic pages are involved, the server-side system 202 needs to prepare the web pages and send to them browser. Here, partially filled forms, data sheets, etc. may be stored in the server-side system 202 as well as the browser-side system 402, when the session is saved. After the session resumes and when the entry process is complete at the user's end, the user submits the entered data; also, the server-side system 202 updates the stored web pages. Thus, the server-side system 202 and the browser-side system 402 are synchronized, allowing forms, data sheets, etc. to be filled over multiple sessions.

The login session may be associated to, for example, online purchase of a flight ticket. The user may navigate several web pages of a flight ticket purchase form. On termination of the login session due to loss of internet connectivity, or saving by the user, the login session can be resumed from the web page where the login session was terminated. It should be noted that some embodiments of the present disclosure preclude the necessity of re-filling the previous web pages of the form, since the entered information is stored in the form of state information, allowing the user to continue filling the form from the last viewed web page.

As shown in FIG. 6C, in response to the block 6050, the server-side system 202 continues sending the requested web pages to the browser-side system 402 at block 6082. It will be understood that FIG. 6C is a continuation of FIG. 6B, as shown by the connector “B.” Block 6084 displays the web pages transmitted by the server-side system 202. While browsing the web pages at the block 6084, the user may select the save option displayed on the web browser to save the current web session, thereby setting the value of a “clicked save button” parameter as ‘true’. Otherwise, a ‘false’ value is assigned to the “clicked save button” parameter. Block 6086 determines the value of the “clicked save button” parameter. If the value of the “clicked save button” parameter is ‘true’, the block 6086 leads to block 6088, where the “TID-session” parameter's value is determined. If the value of the “TID-session” parameter is ‘true’, it is determined that the current web session is a continuation of the previous web session, and block 6090 sends a request from the browser-side system 402 to the server-side system 202 for updating the TID. The server-side system 202 updates the TID and the corresponding state information at block 6092. After updating the TID and the state information, the server-side system 202 sends the updated TID and the corresponding state information to the browser-side system 402. Block 6094 saves the updated TID and the state information in the browser-side system 402. After the updated TID and the state information is stored in the browser-side system 402, the user may submit a new URL request as represented by the connector 1.

If the block 6088 determines that the value of the “TID-session” parameter is ‘false’, the block 6088 leads to the block 6096. The block 6096 transmits the MAC address of the client machine from the browser-side system 402 to the server-side system 202 and a request for generating TID corresponding to the current web session. The server-side system 202 generates the new TID and transmits the generated TID to the browser-side system 402 at block 6098. The block 6098 returns to the block 6094, which saves the TID in the browser-side system 402. The user may then submit a new URL in the web browser, as represented by the connector 1, returning to the block 6004.

If the block 6086 determines that the value of the “clicked save button” parameter is ‘false’, the block 6086 leads to block 6099. The block 6099 determines whether a file download activity has been initiated by the user, and accordingly, assigns a value to a “clicked file download” parameter. If the value assigned to the “clicked file download” parameter is ‘false’, the browser waits for a user action, such as typing a new URL, as represented by the connector 1, returning to the block 6004. Otherwise, the block 6099 leads to block 6100.

The block 6100 sends a file download request from the browser-side system 402 to the server-side system 202. Once the file download request is transmitted, the server-side system 202, at block 6101, determines whether the current session is a TID session. If the value of the “TID-session” parameter is ‘true’, the block 6110 leads to block 6102.

Upon a determination that the session is not a TID session, the server-side system 202 requests the browser-side system 402 to send the MAC address of the client machine, as shown at block 6104. In response, block 6106 sends the MAC address from the browser-side system 402 to the server-side system 202. The server-side system 202 generates a TID corresponding to the current web session and sets the ‘file download’ field of the corresponding state information to ‘true’, at block 6108. Further, at block 6108, the server-side transmits the generated TID and the state information to the browser-side system 402. The block 6110 saves the TID, web page information, and file download information, such as percentage of file downloaded and the like, in the browser-side system 402. The block 6110 leads to a connector C.

If the block 6101 determines that the session is a TID session, the block 6101 leads to the block 6102, which sends a request to the server-side system 202 for updating the TID and the corresponding state information. At block 6112, the server-side system 202 updates the TID, sets the ‘file download’ field of the state information to ‘true’, and sends the updated TID and the state information to the browser-side system 402. After receiving the updated TID and the state information, the block 6112 leads to the block 6110, which saves the TID, the web page information, and the file download information. As disclosed, the block 6110 leads to the connector C.

The connector C leads to FIG. 6D, which is a continuation of FIG. 6C. As shown in FIG. 6D, block 6114 continues saving the downloaded files sent by the web server at the browser-side system 402. At block 6116, the web server determines whether the session is a TID session and whether the file download of the previous web session is to be resumed or a new file download activity is to be initiated. If the session is a TID session, the server-side system 202 updates the ‘file download’ field of the state information corresponding to the TID and sends the requested files to the browser-side system 402.

The block 6116 returns to the block 6114, which saves the transmitted files and leads to block 6118. The block 6118 determines whether the internet connection is present. If there is discontinuity in the internet connectivity, an “internet connection” parameter's value is set to ‘false’ and the block 6118 leads to block 6120, which saves the TID and the state information in the browser-side system 402. After the TID and the state information are saved in the browser-side system 402, the user may submit a new URL request, as represented by the connector 1, returning to the block 6004. Otherwise, the “internet connection” parameter's value is set to ‘true’ and the block 6118 leads to block 6121. Here, it is determined whether the user clicks on a save button to save the session.

If the user clicks on the save button, the block 6121 returns to the block 6090, as shown by a connector “D”, where the block 6090 sends a request from the browser-side system 402 to the server-side system 202 for updating the TID. Otherwise, the block 6121 leads to block 6122 to determine a value of a “file download complete” parameter. If the block 6122 determines that the value of the “file download complete” parameter is ‘false’, or in other words, if the file download activity is incomplete, the block 6122 returns to the block 6114. Otherwise, the block 6122 leads to block 6124, where the server-side system 202 and the browser-side system 402 both determine whether the session is a TID session. If the session is a TID session, at block 6126, the server-side system 202 detaches the ‘file download’ field from the state information and sends the TID to the browser-side system 402. Block 6128 retains the received TID in the browser-side system 402. The user may then submit a new URL request, as represented by the connector 1, returning to the block 6004.

If the server-side system 202 determines that the session is not a TID session, the server-side system 202 removes the TID at block 6130. In addition, block 6132 removes the TID and the corresponding state information from the browser-side system 402. The user may then submit a new URL, as shown by the connector 1, returning to the block 6004.

Those skilled in the art will understand that the system and methods set out in the discussion above may be combined or altered in specific adaptations of the disclosure. The illustrated system and methods are set out to explain the illustrated embodiments, and it should be anticipated that ongoing technological development will change the manner in which particular functions are performed. These depictions do not limit the scope of the disclosure, which is determined solely by reference to the appended claims.

### CONCLUSION

The present disclosure provides the server-side system 202 and the browser-side system 402, and the computer-implemented method 500, for facilitating continuation of a web session after the web session has been terminated. The systems and methods disclosed herein provide an efficient and secure manner of continuing a terminated web session at a later time, using a TID. In addition, the same TID can be used for a given URL, irrespective of the number of browser connections open, resulting in a single state for the URL that is stored in the client-machine and the web server. Since the MAC addresses of the client-machine and/or the server-machine may be used to generate the TID, the TID cannot be decrypted easily and thus imparts additional security. A partial file download activity can also be resumed at a later time using the disclosed TID.

The specification sets out a number of specific exemplary embodiments, but persons of skill in the art will understand that variations in these embodiments will naturally occur in the course of embodying the subject matter of the disclosure in specific implementations and environments. For example, any other suitable distinguishing information may be utilized to generate transaction identifier, apart from MAC address of the client machine. It will further be understood that such variations, and others as well, fall within the scope of the disclosure. Neither those possible variations nor the specific examples set above are set out to limit the scope of the disclosure. Rather, the scope of claimed disclosure is defined solely by the claims set out below.

What is claimed is:

1. A computer-implemented method, executed on a web server, for facilitating continuation of a web session after the web session has been terminated, the method comprising:
initiating a web session with a URL upon receiving a request from a web browser, the web session having an associated web page;
generating session information related to the web session, including a transaction identifier and state information;
transmitting the session information to a web browser;
terminating the web session;
resuming the web session, the resuming comprising:
accepting the session information from the web browser;
authenticating the transaction identifier of the session information; and
validating the client data corresponding to the authenticated transaction identifier; and
continuing the web session at the web page.

2. The computer-implemented method of claim 1, wherein the resuming further comprises:
identifying an existing transaction identifier for the URL;
validating the existing transaction identifier;
updating the existing transaction identifier; and
transmitting the updated transaction identifier to the web browser.

3. The computer-implemented method of claim 1, wherein the resuming further comprises:
receiving a web page request from the web browser; and
transmitting session identifier status information to the web browser.

4. The computer-implemented method of claim 1 further comprising saving the resumed web session.

5. The computer-implemented method of claim 4 further comprising updating the session information.

6. The computer-implemented method of claim 1 further comprising initiating a file download activity during the resumed web session.

7. The computer-implemented method of claim 6 further comprising updating the session information.

8. The computer-implemented method of claim 1, the session information being generated when a file download activity is initiated.

9. The computer-implemented method of claim 8 further comprising:
saving the transaction identifier by the web server, upon determination that internet connectivity is lost; and
saving the session information by the web browser, upon determination that internet connectivity is lost.

10. The computer-implemented method of claim 8 further comprising discarding the session information once the file download activity is completed during the web session.

11. The computer-implemented method of claim 8 further comprising discarding the state information once the file download activity is completed during the resumed web session.

12. The computer-implemented method of claim 1, wherein the session information is generated when the web session is saved.

13. The computer-implemented method of claim 1, wherein generating the session information further comprises receiving, during the web session, at least one of:
the client data;
server data; or
date stamp of the web server;
wherein one or more of the client data, the server data, and the date stamp are utilized to generate the transaction identifier.

14. The computer-implemented method of claim 1, wherein the session information is generated when internet connectivity is lost, or the web session is saved.

15. The computer-implemented method of claim 1, wherein the state information comprises information of at least one of a web page session, a file download session, or a login session.

16. A system for facilitating continuation of a web session, after the web session has been terminated, the system comprising:
a server-computing module configured to:
generate session information related to the web session, including a transaction identifier and state information; and
transmit the session information to a web browser;
a server-initiation module operatively coupled to the server-computing module, the server-initiation module configured to:
initiate a web session with a URL upon receiving a request from a web browser, the web session having an associated web page;
resume the web session after the web session has been terminated;
accept the session information related to the web session from the web browser;
authenticate the transaction identifier of the session information; and
validate the client data corresponding to the authenticated transaction identifier; and
a server-processing module operatively coupled to the server-initiation module, the server-processing module configured to continue the web session at the web page.

17. The system of claim 16, wherein the server-initiation module is further configured to:
identify an existing transaction identifier for the URL;
validate the existing transaction identifier;
update the transaction identifier; and
transmit the updated transaction identifier to the web browser.

18. The system of claim 16, wherein the server-processing module is further configured to:
initiate a file download activity during the resumed web session; and
update the session information.

19. The system of claim 16, wherein the transaction identifier is generated when a file download activity is initiated.

20. The system of claim 19, wherein the server-processing module is further configured to save the session information, upon determination that internet connectivity is lost.

21. The system of claim 19, wherein the server-processing module is further configured to perform one of:
discarding the session information once the file download activity is completed during the web session; or
discarding the state information once the file download activity is completed during the resumed web session.

22. The system of claim 16, wherein the session information is generated when the web session is saved or the internet connection is lost.

23. The system of claim 16, wherein the server-computing module is further configured to receive, during the web session, at least one of:
the client data;
server data; or
date stamp of the web server;
wherein the client data, the server data, and the date stamp are utilized to generate the transaction identifier.

24. The system of claim 16, wherein the state information comprises information of at least one of a web page session, a file download session, or a login session.

25. A computer-implemented method for facilitating continuation of a web session, after the web session has been terminated, the method comprising:
initiating a web session with a URL upon receiving a request from a web browser, the web session having an associated web page;
generating session information by a web server, including transaction identifier and state information;
receiving the session identifier by the web browser from the web server;
terminating the web session;
resuming the web session including:
accepting the session information by the web server from the web browser;
authenticating the transaction identifier of the session information by the web server; and
validating client data corresponding to the authenticated transaction identifier by the web server; and
continuing the web session at the web page.
